(19) United States
(12) Patent Application Publication
(10) Pub. No.: US 2024/0114371 A1
(43) Pub. Date: Apr. 4, 2024

(54) ATTAINING RAPID RADIO FREQUENCY (RF) CHANNEL INSPECTION USING INTELLIGENT TRANSCEIVER SCANNING IN WLAN NETWORKS

(71) Applicant: Fortinet, Inc., Sunnyvale, CA (US)

(72) Inventor: Srinivasa Subbarao Neeli, Whitefield (IN)

(21) Appl. No.: 17/957,762

(22) Filed: Sep. 30, 2022

(51) Int. Cl. H04W 24/10; H04W 12/121

(52) U.S. Cl. CPC H04W 24/10; H04W 12/121; H04W 84/12

(57) ABSTRACT

Scan mode is configured in an access point to monitor WLAN conditions. A channel list is progressively scanned using full capabilities available from MIMO transceivers. During a hop period, each MIMO transceiver is configured to a first set of channels from the channel list within an RF band. During a dwell period, an RF analysis is performed for the set of channels to identify conditions on the WLAN.

### FIELD OF THE INVENTION

The invention relates generally to computer networking computer security, and more specifically, to attaining rapid RF channel inspection using intelligent MIMO (multiple input/multiple output) transceiver scanning in WLAN networks.

### BACKGROUND

WLAN (Wireless Local Area Network) devices are eligible to operate in two unlicensed RF bands, 2.4 GHz RF band and the other is 5 GHz RF band. The 2.4 GHz RF band ranges from 2401 MHz through 2495 MHz, with a total 14 different channels will be available for the WLAN devices to operate (channels 1 through 14).

Similarly, 5 GHz RF Band allows WLAN devices to select and operate over huge list of channels which ranges from 5170 MHz through 5330 MHz and 5490 MHz through 5815 MHz. This entire Frequency range is notated as UNII-I (channels 36 through 48), UNII-2 (channels 52 through 64), UNII-2 Extended (Channels 100 through 144) and UNII-3 (Channels 149 through 161). Altogether, over 5 GHz band, WLAN devices have 24 different channels to operate.

Due to the co-existence with other devices like Microwave ovens and Bluetooth devices, 2.4 GHz band has its own challenges like Interference etc. As the usage of WLAN network is growing day by day in different sectors, more 5 GHz capable devices are getting emerged in the market as 5 GHz RF band provides more channels to operate. As the count of 5 GHz capable devices are getting increased drastically, even 5 GHz spectrum is getting exhausted to support these huge count of WLAN operations. To overcome this issue, a new standard called Wi-Fi 6E was designed.

More specifically, the Wi-Fi 6E standard specifies that Frequency range from 5710 MHz through 7125 MHz (called 6 GHz spectrum) will also be an unlicensed spectrum, so that IEEE 802.11 capable devices can utilized this frequency range for RF transmissions. 6 GHz RF band was notated as UNII-5 (with 24 channels), UNII-6 (with 5 channels), UNII-7 (with 17 channels), and UNII-8 (with 13 channels). Hence, with 6 GHz RF support total 59 different channels will be available for WLAN devices to operate.

With the availability of this enormous frequency ranges, WLAN Access points will have different channel options to select and operate. For getting served with the WLAN access points, WLAN client devices have to perform RF scanning by a method of sending probes. During this scanning process, WLAN client devices has to tune their radios to each and every channel which are supported over these different RF bands (i.e., 2.4 GHz, 5 GHz, 6 GHz). Scanning will to be performed on each and every channel by the WLAN client device in the process of identifying the access points and their capabilities.

To avoid interfering with each other access points will choose their channels to operate by considering there neighboring Access Points operating channels. Hence at any particular vicinity two Access points will not choose the same channel to operate. Also, WLAN client device will perform their initial connectivity scanning in ascending order starting from the base channel available on the selected RF band to the highest available channel. At a vicinity of where client was scanning, if access point was operating at the base channel, WLAN client can get associated with the access point much quickly as the count of channels to perform scan will be lesser.

Consider a case where access point was operating at the highest available channel on an RF band (2.4 GHz, 5 GHz, 6 Ghz). Here, when a WLAN client is trying to establish a connection with the access point, it has to scan the entire frequency range by tuning its radio to each and every available channel and then gets associated at the last available frequency in the RF band were access point was operating. For Example, an access point was operating in UNII-8 of 6 GHz RF band at a particular vicinity. To get served with the access point, WLAN client has to complete its scanning starting from UNII-5, UNII-6, UNII-7 which are around 46 different channels and then at last will scan the UNII-8 frequency range and will get associated. Similarly, even for 5 GHz RF band and 2.4 GHz RF band the same process is applicable.

Problematically, WLAN client devices has to perform scanning on the entire RF range for their initial connection establishment with the access points. WLAN clients has to face delay in initial connection establishment with the Access points by scanning the entire enormous frequency range. Client Connection establishment over RF band's like 6 GHz (Wi-Fi 6E) spectrum which has huge frequency range will be delayed as client has to scan the entire frequency range to identify the appropriate access Point for getting served.

Therefore, what is needed is a robust technique for attaining rapid RF channel inspection using intelligent MIMO (multiple input/multiple output) transceiver scanning in WLAN networks.

### SUMMARY

These shortcomings are addressed by the present disclosure of methods, computer program products, and systems for attaining rapid RF channel inspection using intelligent MIMO (multiple input/multiple output) transceiver scanning in WLAN networks.

In one embodiment, a Wi-Fi controller coordinates which access points scan and which access points service clients, and when changes are necessary. Scan mode is configured to monitor WLAN conditions. To do so, supported RF bands are identified, such as 2.4 Ghz, 5 Ghz and 6 Ghz. From the bands, a list of channels is determined, for example, 59 or 161 channels from each band if all are scanned.

In one implementation, the channel list is progressively scanned using full capabilities available from MIMO transceivers. During a hop period, each MIMO transceiver is configured to a first set of channels from the channel list within an RF band. During a dwell period, an RF analysis is performed for the set of channels to identify conditions on the WLAN.

Advantageously, network performance is improved by eliminating attacks. In turn, networking hardware also performs better with less network disruptions.

### BRIEF DESCRIPTION OF THE DRAWINGS

In the following drawings, like reference numbers are used to refer to like elements. Although the following figures depict various examples of the invention, the invention is not limited to the examples depicted in the figures.

FIG. 1 are high-level block diagrams illustrating a wireless communication system for attaining rapid RF channel inspection using intelligent MIMO transceiver scanning in WLAN networks, according to one embodiment.

FIG. 2 is a more detailed block diagram illustrating an access point of the system of FIG. 1, according to an embodiment.

FIG. 3 is a more detailed block diagram illustrating a MIMO transceiver chain of the access point of FIG. 2, according to an embodiment.

FIG. 4 is a high-level flow diagram illustrating a method for attaining rapid RF channel inspection using intelligent MIMO transceiver scanning in WLAN networks, according to one embodiment.

FIG. 5 is a more detailed flow diagram illustrating a step of progressively scanning a channel list of the method of FIG. 4, according to an embodiment.

FIG. 6 is a block diagram illustrating an example computing device for the components of FIG. 1, according to one embodiment.

### DETAILED DESCRIPTION

The description below provides methods, computer program products, and systems for attaining rapid RF channel inspection using intelligent MIMO transceiver scanning in WLAN networks. One of ordinary skill in the art will recognize many additional variations made possible by the succinct description of techniques below.

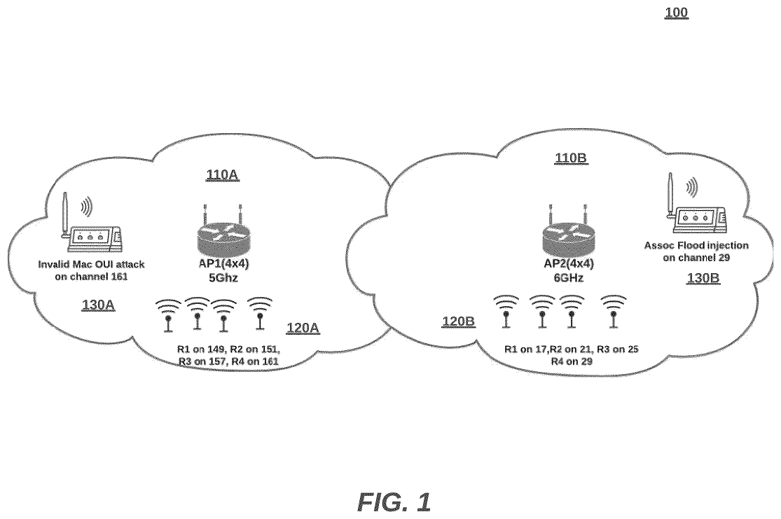

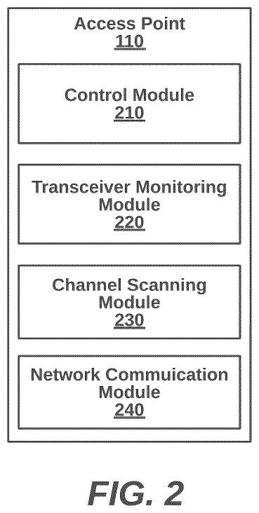

I. Systems for Rapid RF Channel Inspection (FIG. 1-2)

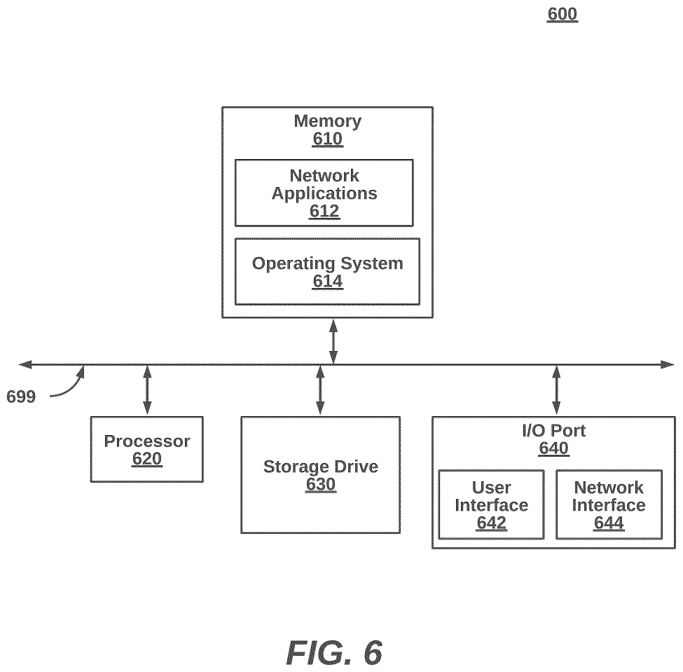

FIG. 1 are high-level block diagrams illustrating a system 100 for attaining rapid RF channel inspection using intelligent MIMO transceiver scanning in WLAN networks, according to one embodiment. The system 100 includes access points 110A,B having MIMO transceivers 120A,B coupled through a WLAN network. Rogue access points 130A,B, are within range of the access points 110A,B for attacks. Many other embodiments are possible, for example, with more or fewer access points, more or fewer stations, and additional components, such as firewalls, routers and switches. Hardware and software components can be implemented similar to the example of FIG. 6.

A wide area network 199 links components of the system 100 with a channel for data communication. The access points 110A,B are preferably connected to the wide area network via hardwire. Clients can be wirelessly connected to the access points 110A,B, when in service mode rather than scanning mode, to access the wide area network indirectly. The wide area network can be a data communication network such as the Internet, a WAN, a LAN, WLAN, can be a cellular network (e.g., 3G, 4G, 5G or 6G), or a hybrid of different types of networks. Thus, the system 100 components can be located locally on a LAN to communicate with remote and cloud-based devices.

The access points 110A,B, scan a channel list using full capabilities of the MIMO transceivers 120A,B, by configuring scanning of multiple channels at the same time rather than a single channel at a time. In the system 100, access point 110A has a 4×4 MIMO capability, currently tuned to the 5 Ghz band. Radio 1 is on channel 149, radio 2 is on channel 151, radio 3 is on channel 157 and radio 4 is on channel 141. Meanwhile, access point 110B also has a 4×4 MIMO capability and is currently tuned to the 6 Ghz band. Radio 1 is scanning channel 17, radio 2 is scanning channel 21, radio 3 is scanning channel 25 and radio 4 is scanning channel 29. In one embodiment, radio ranges are mutually exclusive and both access points 110A,B independently scan all channels. In another embodiment, radio ranges are overlapping and access points 110A,B share scanning tasks as coordinated by a Wi-Fi controller with management authority over both devices.

The rogue access points 130A,B can be a foreign device used to disrupt the system 100. Attacks can be directly on the access points 110A,B or on clients served by other access points on the system 100. In this case, the rogue access point 130A is using an invalid MAC OUI attack on channel 161. Under the prior art, by the time channel 161 is scanned, there may already be damage. The rogue access point 139B is using an association flood injection on channel 29 to disrupt operations. Once discovered by the RF scanning analysis discussed herein, remediations can be asserted to shut down or reduce the attacks.

In service mode, the access points 110A,B rapidly connect to MIMO and non-MIMO clients over a broadband frequency of Wi-Fi, such as 2.4 GHz, or 5.0 GHz, 6.0 GHz (or future larger frequency uses). Beacons are broadcast to advertise to clients that an SSID and certain capabilities are available, and the clients choose to connect to an access point. Once connected, the access point 110A can provide can exchange data between the connecting station 120A and resources on the WAN 199 or between other clients on the WLAN. Policies can be implemented that restrict certain traffic exchanges. Additionally, mobile clients can be transparently handed over (e.g., voluntary or forced hand off) from one access point to another access point without disruption to data communications by sharing SSIDs. One embodiment of the system 100 includes one or more Wi-Fi controllers to manage multiple access points and to uniformly manage clients moving among the multiple access points.

In some embodiments, the access points 110A-C comply with IEEE 802.11 protocols for 5.0 GHz and 6.0 GHz transmission. For instance, 160 MHz bandwidth channels can operate under IEEE 802.11, or more specifically IEEE 802.11AX (or Wi-Fi 6), over allowed frequencies. The access points 110A-C can also have combinations of 80 MHz, 40 MHz and 20 MHz bandwidth channels available for stations. In one example, the access points 110A-Bare hardware built for beamforming for bi-directional MU-MIMO (multiple-user, multiple input, multiple output) with multiple antennae in, for example, 2×2, 3×3, 4×4 or 8×8 stream variations. Different modulation schemes can be implemented, such as QAM and OFDMA (orthogonal frequency division multiple access). Access points of an implementation downgrade stations from 6 GHz to 5 GHz, or 5 GHz to 2.4 GHz, as necessary to prevent congestion. Additional airtime fairness techniques can be implemented by access points in combination with the presently implemented WLAN uplink device 120 steering techniques. Access points can measure the signal strength and flight time from various stations based on data packets received from those stations. Local network statistics can be collected and sent upstream from system-wide monitoring. The access points 110A-C are described in more detail below with respect to FIG. 2.

Client being service by access points can be enabled for 5 GHz or 6 GHz. Channel bandwidths can be enabled for 160 MHZ, 80 MHz, 40 MHz or 20 MHz. Communications use beamforming with MU-MIMO for parallel data transmissions with high throughput. A probe request to join a Wi-Fi network and receive available SSIDs. Any designated access point within range can respond to a particular stations and other access points can ignore the particular stations (e.g., by MAC address).

The network components of the system 100 can implemented in any of the computing devices discussed herein, for example, a personal computer, a laptop computer, a tablet computer, a smart phone, a smart watch, a mobile computing device, a server, a cloud-based device, a virtual device, an Internet appliance, an IoT (Internet of things) device, or any of the computing devices described herein, using hardware and/or software (see e.g., FIG. 6).

FIG. 2 is a more detailed block diagram illustrating an access point 110 (representative of access points 110A or 110B) of the system 100, according to an embodiment. The access point 200 includes a control module, a transceiver monitoring module 220, a channel scanning module 230, and a network communication module 240. The components can be implemented in hardware, software, or a combination of both.

The control module 210 can communicate with a Wi-Fi controller or other access points to determine the parameters of scanning. A network administrator can log in to directly affect processes and APIs can open channels with other devices for automatic configuration. In one example, a Wi-Fi controller coordinates which access points scan and which access points service clients, and when changes are necessary.

The transceiver monitoring module 220 configures a radio to scan mode to monitor WLAN conditions. To do so, supported RF bands are identified, such as 2.4 Ghz, 5 Ghz and 6 Ghz. From the bands, a list of channels is determined, for example, 59 channels from each band if all are scanned. However, some channels may be excluded from scanning. Further, the transceiver monitoring module 220 can count the number of scan radios on a MIMO transceiver.

A channel scanning module 230, in one implementation, progressively scans the channel list. During a hop period, each MIMO transceiver is configured to a first set of channels from the channel list within an RF band. During a dwell period, an RF analysis is performed for the set of channels to identify conditions on the WLAN. Depending on configurations, the RF transceiver configuration and the RF analysis performance is continuous for subsequent sets of channels on the channel list. In another case, a single pass of scanning is sufficient. In other case, scanning is periodic according to a schedule or is triggered from another condition.

Finally, the network communication module 240 includes a MIMO transceiver chain 242 as part of providing communication protocols, software and hardware for network communication. An idle transceiver of the MIMO transceiver chain is tuned to a first channel of a baseband and at least one non-idle transceiver of the MIMO transceiver chain is tuned to a second channel of the baseband for service to Wi-Fi clients.

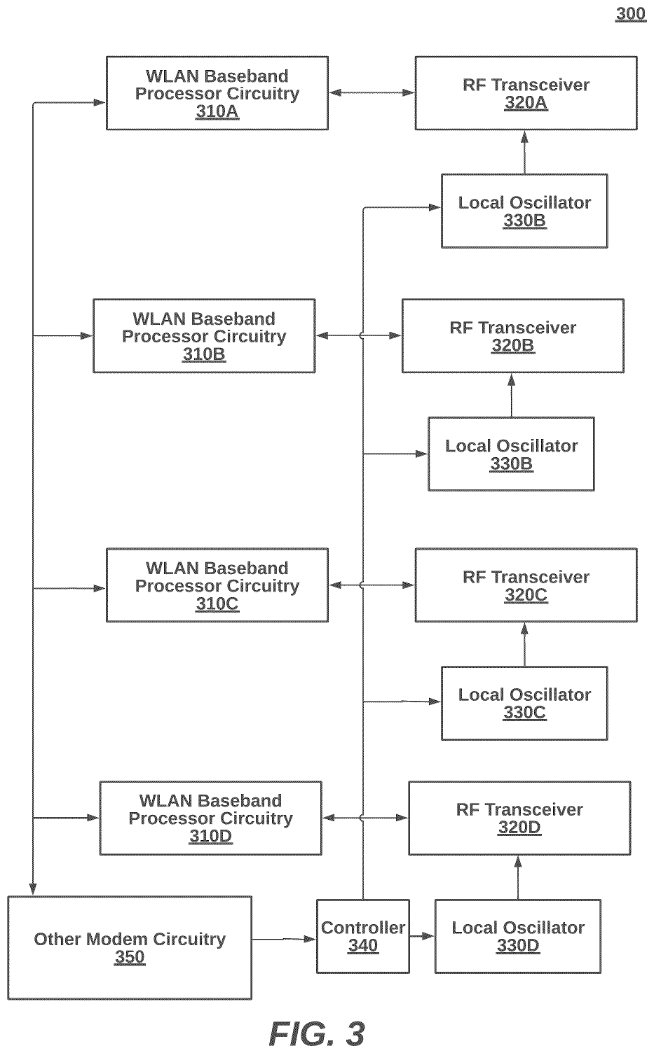

An example MIMO transceiver 120 (representative of either MIMO transceiver 120A or 120B) is shown in FIG. 3. Each of the RF transceivers 320A-D receives an LO signal from a corresponding local oscillator 330A-D to transmit data from a corresponding WLAN baseband processor circuitry 310A-D. The local oscillators 330A-C can be implemented with a PLL (phase locked loop). A controller 340 can manage and coordinate the local oscillators 330A-D. Additional modem operations, such as memory and antennae can be implemented in other modem circuitry 350.

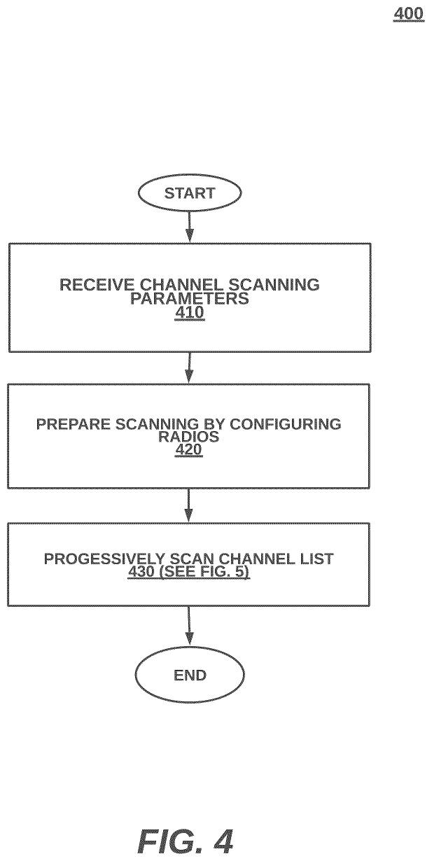

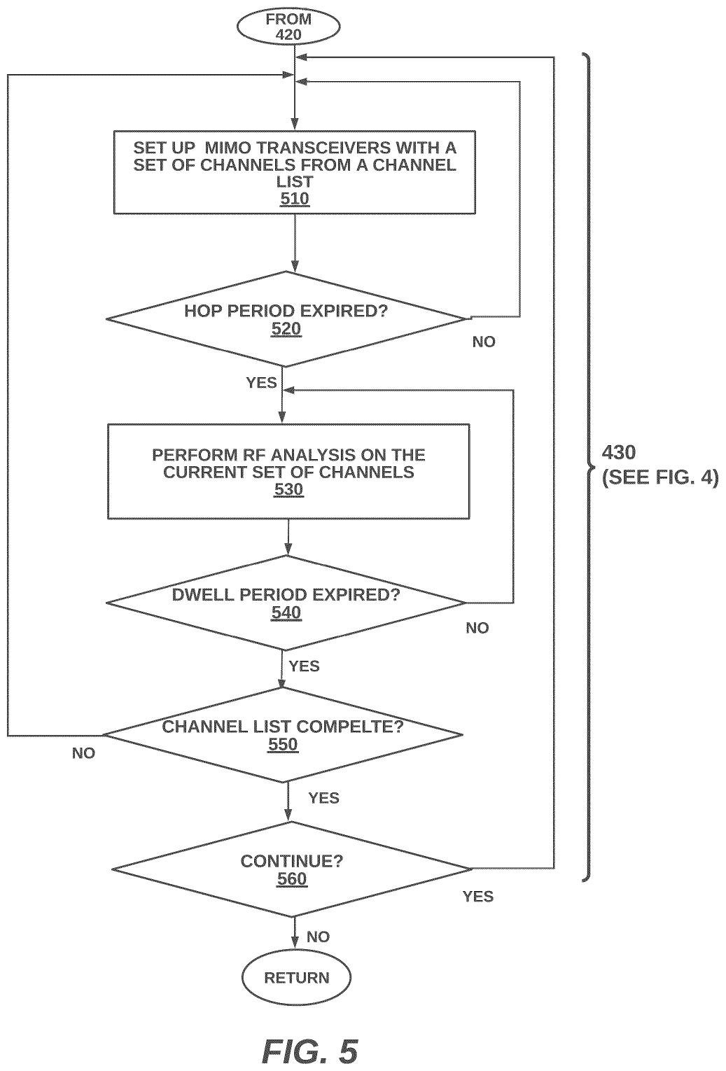

II. Methods for Rapid RF Channel Inspection (FIGS. 4-5)

FIG. 4 is a high-level flow diagram illustrating a method for using artificial intelligence to drive stations with 6 GHz uplink capability across access points of a wireless network, according to one embodiment. The method 400 can be implemented, for example, by the system 100 of FIG. 1. The steps are merely representative groupings of functionality, as there can be more or fewer steps, and the steps can be performed in different orders. Many other variations of the method 400 are possible.

At step 410, channel scanning parameters are received from a network administrator, a Wi-Fi controller, other access points, or the like.

At step 420, scanning is prepared by configuring a radio to scan mode to monitor WLAN conditions. To do so, supported RF bands are identified in order to compile a list of channels. A number of MIMO radios is determined from configurations or the operating system.

At step 430, the channel list is progressively scanned, as detailed in FIG. 5. At step 510, a first set of channels from the channel list is set up on each MIMO transceiver for scanning. After expiration of a hop period, at step 520, an RF analysis is performed for the set of channels to identify conditions on the WLAN, at step 530. After expiration of a dwell period, at set 540, an RF analysis is performed to identify issues on the WLAN, at step 550. Then at step 560, it is determined whether the list has been completed, and if so, whether to continue scanning, at set 570.

III. Generic Computing Device for Fast Connections (FIG. 6)

FIG. 6 is a block diagram illustrating an example computing device 600 for use in the system 100 of FIG. 1, according to one embodiment. The computing device 600 is implementable for each of the components of the system 100 including access points 110A,B. The computing device 600 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 600, of the present embodiment, includes a memory 610, a processor 620, a storage drive 630, and an I/O port 640. Each of the components is coupled for electronic communication via a bus 699. Communication can be digital and/or analog and use any suitable protocol.

The memory 610 further comprises network applications 612 and an operating system 614. The network applications 612 can include a web browser, a mobile application, an application that uses networking, a remote application executing locally, a network protocol application, a network management application, a network routing application, or the like.

The operating system 614 can be one of the Microsoft Windows® family of operating systems (e.g., Windows 96, 98, Me, Windows NT, Windows 2000, Windows XP, Windows XP x64 Edition, Windows Vista, Windows CE, Windows Mobile, Windows 6 or Windows 8), Linux, HP-UX, UNIX, Sun OS, Solaris, Mac OS X, Alpha OS, AIX, IRIX32, IRIX64, or Android. Other operating systems may be used. Microsoft Windows is a trademark of Microsoft Corporation.

The processor 620 can be a network processor (e.g., optimized for IEEE 802.11, IEEE 802.11AC or IEEE 802.11AX), a general-purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 620 can be single core, multiple core, or include more than one processing elements. The processor 620 can be disposed on silicon or any other suitable material. The processor 620 can receive and execute instructions and data stored in the memory 610 or the storage drive 630.

The storage drive 630 can be any non-volatile type of storage such as a magnetic disc, EEPROM (electronically erasable programmable read-only memory), Flash, or the like. The storage drive 630 stores code and data for applications.

The I/O port 640 further comprises a user interface 642 and a network interface 644. The user interface 642 can output to a display device and receive input from, for example, a keyboard. The network interface 644 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, Cif, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. An access point in a data communication network for attaining rapid RF channel inspection using intelligent MIMO (multiple input/multiple output) transceiver scanning in WLAN networks, the access point comprising:
a processor;
a network interface, comprising a MIMO transceiver chain and communicatively coupled to the data communication network and to a Wi-Fi network, wherein an idle transceiver of the MIMO transceiver chain is tuned to a first channel of a baseband and at least one non-idle transceiver of the MIMO transceiver chain is tuned to a second channel of the baseband for service to Wi-Fi clients; and
a memory, storing source code comprising:
a first module to configure a radio to scan mode to monitor WLAN conditions, to identify scan radio supported RF bands and building a list of channels corresponding to the supported RF bands, and to retrieve an RF transceiver count of scan radios on a MIMO transceiver;
a second module to progressively scan the channel list, comprising, during a hop period, configuring each MIMO transceiver to a first set of channels from the channel list within an RF band, during a dwell period, performing an RF analysis for the set of channels to identify conditions on the WLAN, and repeating the RF transceiver configuration and the RF analysis performance for subsequent sets of channels on the channel list.

2. The access point of claim 1, wherein the MIMO transceiver comprises either a 2×2, a 3×3 or a 4×4 MIMO transceiver chain.

3. The access point of claim 1, wherein the RF transceiver comprises a 4×4 MIMO transceiver chain and a highest capability for a plurality of connected Wi-Fi clients is one of either 3×3 or 2×2 RF transceiver.

4. The access point of claim 1, wherein the first channel comprises a UNII-5 channel and the second channel comprises at one of either a UNII-6, a UNII-7 or a UNII-8 channel.

5. The access point of claim 1, wherein the first channel comprises a UNII-1 channel and the second channel comprises at UNII-3 channel.

6. The access point of claim 1, wherein the Wi-Fi client is configured to scan the channel list in sequential order.

7. The access point of claim 1, wherein the RF band comprises either one of 2.4 GHz, 5.0 GHz and 6.0 GHz.

8. The access point of claim 1, wherein the second module ignores the probe request responsive to the Wi-Fi client already being currently associated with the access point for service.

9. The access point of claim 1, further comprising:
an RF repair module to automatically address issues identified during RF analysis.

10. A non-transitory computer-readable media storing source code that, when executed by a processor, performs a computer-implemented method, in an access point coupled to a plurality of access points on a data communication network, for attaining rapid RF channel inspection using intelligent MIMO (multiple input/multiple output) transceiver scanning in WLAN networks, the method comprising the steps of:
configuring a radio to scan mode to monitor WLAN conditions;
identifying scan radio supported RF bands and building a list of channels corresponding to the supported RF bands;
retrieving an RF transceiver count of scan radios on a MIMO transceiver; and
progressively scanning the channel list, comprising:
during a hop period, configuring each MIMO transceiver to a first set of channels from the channel list within an RF band;
during a dwell period, performing an RF analysis for the set of channels to identify conditions on the WLAN; and
repeating the RF transceiver configuration and the RF analysis performance for subsequent sets of channels on the channel list.

11. A computer-implemented method an access point coupled to a plurality of access points on a data communication network, for attaining rapid RF channel inspection using intelligent MIMO (multiple input/multiple output) transceiver scanning in WLAN networks, the Wi-Fi controller comprising:
configuring a radio to scan mode to monitor WLAN conditions;
identifying scan radio supported RF bands and building a list of channels corresponding to the supported RF bands;
retrieving an RF transceiver count of scan radios on a MIMO transceiver; and
progressively scanning the channel list, comprising:
during a hop period, configuring each MIMO transceiver to a first set of channels from the channel list within an RF band;
during a dwell period, performing an RF analysis for the set of channels to identify conditions on the WLAN; and
repeating the RF transceiver configuration and the RF analysis performance for subsequent sets of channels on the channel list.
